(19) United States
(12) Patent Application Publication
(10) Pub. No.: US 2011/0272238 A1
(43) Pub. Date: Nov. 10, 2011

(54) COMPOSITE COMPONENTS HAVING VARIABLE SURFACE PROPERTIES

(75) Inventors: Soumendra K. Basu, Johnson City, TN (US); Yang T. Cheng, Troy, MI (US)

(73) Assignee: GM GLOBAL TECHNOLOGY OPERATIONS, INC., Detroit, MI (US)

(21) Appl. No.: 12/774,135

(22) Filed: May 5, 2010

(51) Int. Cl. F16D 13/64; B32B 7/02; B32B 3/30; B32B 9/04; B32B 15/04; B21D 31/00; B32B 27/30; B32B 27/32; B32B 27/40; B32B 25/12; B29C 67/00; B32B 9/00; B32B 27/00

(52) U.S. Cl. 192/107 M; 428/411.1; 428/212; 428/213; 428/216; 428/152; 428/446; 428/457; 428/500; 428/522; 428/521; 428/423.1; 428/419; 428/492; 264/345; 192/107 R; 72/364

(57) ABSTRACT

One exemplary embodiment comprises a load transfer device that includes a composite component having a variable and controllable surface roughness. The component may comprise a base substrate, a compliant layer over the base substrate, and a top layer over the compliant layer. The complaint layer and the top layer may act cooperatively to reversibly generate wrinkles in response to changes in temperature of the composite component.

### TECHNICAL FIELD

The technical field generally relates to composite components having a variable and controllable surface roughness.

### BACKGROUND

Some load transfer devices may rely on certain surface properties of their various components for their operation. In many instances these components have surfaces that may experience repeated engagement and disengagement with other surfaces under selectively exerted forces. The frictional interaction between such surfaces can affect their functional characteristics and even provide the load transfer device with a greater range of operational capabilities.

For example, the coefficient of friction of a component's surface within a load transfer device may be relevant to a variety of often-encountered issues such as, but not limited to, surface slip constraints, lubricant retention, heat dissipation, and anti-shudder characteristics. The coefficient of friction of a particular surface may also be relevant to energy management as a surface with a relatively high coefficient of friction can generally transfer a relatively high torque load with less energy input than a surface with a relatively low coefficient of friction.

The ability to reversibly control the coefficient of friction of a component's surfaces may therefore provide a useful control parameter for the improved and more efficient operation of load transfer devices, while also providing desirable properties and performance to other components or devices.

### SUMMARY OF EXEMPLARY EMBODIMENTS OF THE INVENTION

One exemplary embodiment includes a product comprising a load-transfer device comprising a composite component that has a contacting surface constructed and arranged to selectively engage another surface to transfer power to or from the composite component. The composite component may include a base substrate, a compliant layer over the base substrate, and a top layer over the compliant layer. The compliant layer and the top layer may act cooperatively to reversibly form wrinkles in response to changes in temperature of the composite component.

Another exemplary embodiment includes a product comprising a composite clutch plate. The composite clutch plate may include a contact face configured to selectively engage an opposed high-friction surface layer of another clutch plate to transfer power between the clutch plates. The composite clutch plate may include a base substrate, a compliant layer over the base substrate, and a top layer over the compliant layer. The compliant layer and the top layer may act cooperatively to reversibly form wrinkles in response to changes in temperature of the composite clutch plate.

Another exemplary embodiment includes a product comprising a vehicle that comprises a composite component that has a contact surface. The composite component may comprise a base substrate, a compliant layer over the base substrate, and a top layer over the compliant layer. The compliant layer and the top layer may act cooperatively to reversible form wrinkles in response to changes in temperature of the composite component. The wrinkles, when formed, may have an average peak-to-peak wavelength that ranges from about 50 nm to about 2 mm and an average peak-to-trough amplitude that ranges from about 10 nm to about 10 μm.

Still another exemplary embodiment includes a method of using a load transfer device that comprises a composite component having a contact surface and comprising a base substrate, a compliant layer over the base substrate, and a top layer over the compliant layer.

Other exemplary embodiments of the invention will become apparent from the detailed description that follows. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is, as an example of load transfer device, a cross-sectional fragmentary view of a multi-disc clutch that may be utilized in an automatic transmission;

FIG. 2 is a perspective view of a friction plate and a reaction plate spaced apart from one another and suitable for use in the multi-disc clutch of FIG. 1.

FIG. 3A is a cross-sectional view taken along the line 3-3 of the reaction plate of FIG. 2 and showing, according to one embodiment of the invention, the composite structure of the reaction plate.

FIG. 3B is a cross-sectional view taken along the line 3-3 of the reaction plate of FIG. 2 and showing, according to one embodiment of the invention, the composite structure of the reaction plate after wrinkles have been formed.

### DETAILED DESCRIPTION OF EXEMPLARY EMBODIMENTS

The following description of the embodiments is merely exemplary in nature and is in no way intended to limit the invention, its application, or its uses.

Load transfer devices are commonly used throughout a vehicle to efficiently transfer power in a mechanically practical manner. Examples of commonly known load transfer devices include, among others, torque converters, friction launch devices, automatic and manual transmissions, and limited slip differentials. These devices generally include a driving component, which may be powered by a motor or other similar device, and a driven component, which is constructed to deliver power downstream from the motor. Power may be transferred between the driving component and the driven component by selectively bringing together two or more opposed contacting surfaces of the components under a compressive force. The frictional interaction generated between the contacting surfaces as a result of the compressive force is generally sufficient to at least temporarily couple the components together so that they move jointly, and thus transfer power therebetween, until the compressive force subsides. The manner in which these opposed contacting surfaces interact, however, is not inconsequential. Thus, composite components having a variable and controllable surface roughness have been developed in an attempt to improve the performance and durability of the various load transfer devices found throughout a vehicle.

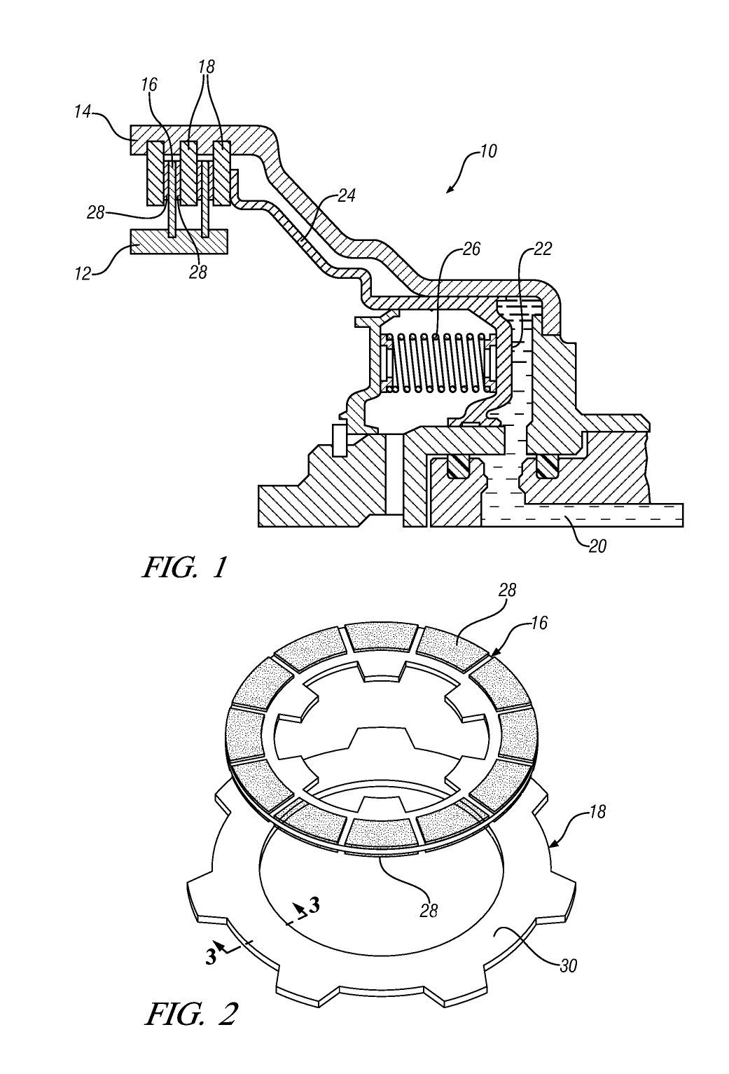

One particular and illustrative embodiment of a load transfer device, as shown in FIG. 1, is a multi-disc clutch 10 for use in a vehicle automatic transmission that comprises several opposed and selectively engageable clutch plates to transfer torque between otherwise uncoupled rotatable shafts. In this embodiment, the multi-disc clutch 10 is configured so that, when selectively engaged, it locks together a planetary gear set's sun gear (not shown) and planet carrier 12. Engaging the multi-disc clutch 10 of this embodiment thus forces the planetary gear set to rotate as a single unit to produce a 1:1 gear ratio between the transmission's input and output shafts (not shown). Skilled artisans will appreciate, however, that the multi-disc clutch 10 shown here can be configured to engage or lock other gear or drive members together and to also achieve different gear set outcomes when engaged or disengaged.

The multi-disc clutch 10 is shown here in an engaged state and includes a series of alternating friction plates 16 and reaction plates 18 that are tightly pressed together. The friction plates 16 may be splined along their inner circumference to the planet carrier 12 and the reaction plates 18 may be splined along their outer circumference to a sun-gear drum 14. To engage the multi-disc clutch 10, a pressurized fluid is delivered through a fluid passage 20 and against an apply side 22 of a clutch piston 24 to axially move the piston 24 and squeeze the plates 16, 18 together as shown. The resulting surface interactions between the friction plates 16 and reaction plates 18 causes them—along with the sun-gear drum 14 and the planet carrier 12—to lock together and rotate at the same speed.

To foster disengagement of the multi-disc clutch 10, a return spring 26 may be biased against the clutch piston 24 to provide a counter force that retracts the piston 24 whenever the fluid pressure against the apply 22 of the clutch piston 24 is suitably decreased. The disengagement of the multi-disc clutch 10 causes the friction plates 16 and the reaction plates 18 to separate and thus rotate independently of one another in association with their respective splined gear members—at least until the multi-disc clutch 10 is re-engaged. The engagement and disengagement of the multi-disc clutch 10 may occur repeatedly during normal vehicle operation to ensure that proper gear shifting is achieved.

Referring now to FIG. 2, there is shown in more detail one of the friction plates 16 and one of the reaction plates 18 of the multi-disc clutch 10. The friction plate 16 may be a typical metal clutch plate that includes a high-friction surface layer 28. This surface layer 28 may be coated, bonded, or otherwise attached along the friction plate's 16 contact face. The opposite side of the friction plate 16, although not entirely visible in FIG. 2, may be similarly configured with a high-friction surface layer due to the alternating arrangement of friction plates 16 and reaction plates 18 in the multi-disc clutch 10. The friction plate 16 may be manufactured from metals such as steel, cast iron, aluminum, and their various alloys. The high-friction surface layer 28 located on the friction plate 16 may be formed from a variety of known materials such as, for example, paper and cellulose fibers bonded together in a Kevlar binder. A graphite coating may also be incorporated onto the high-friction surface layer 28 to enhance the material's thermal conductivity. Other materials that may comprise the high-friction surface layer 28 may include sintered bronze particles and woven carbon fibers.

The reaction plate 18 may comprise a composite plate structure that provides it with a contact face 30 having a variable and controllable surface roughness. This variable surface roughness quality provides the reaction plate 18 with a more robust ability to engage the opposed high-friction surface layer 28 of the friction plate 16. For instance, the reaction plate 18 can assume at any given time a more optimal surface roughness—and thus a more appropriate surface coefficient of friction—depending on the internal or external environment of the multi-disc clutch 10 and/or the desired function of the reaction plate 18 at that time. The particular range of surface roughnesses that can be achieved, and the desired response within that range to any of a variety of known parameters, may be controlled by design to be an essentially predictable and predetermined phenomenon when the reaction plate 18 is exposed to expected operating conditions. It is also possible, however, to more directly control the surface roughness of the contact face 30 so that other more intentional and distinctive adjustments can be made when warranted.

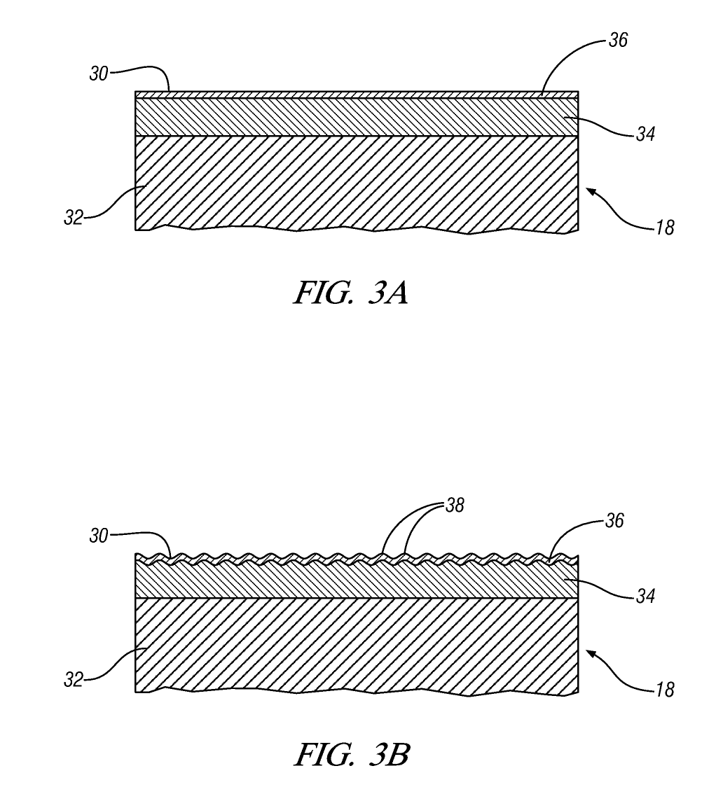

Referring generally now to FIG. 3A-3B, the composite plate structure of the reaction plate 18 may comprise a base substrate 32, a compliant layer 34 applied over the base substrate 32, and a top layer 36 applied over the compliant layer 34. The base substrate 32 may generally be the largest piece of the reaction plate 18 and, as a result, the main source of structural integrity. The base substrate 32 may be comprised of a metal such as steel, cast iron, aluminum, or any other suitable metal, and it may generally be manufactured by a suitable stamping procedure.

The compliant layer 34 and the top layer 36 may then be applied onto the base substrate 32 to provide the reaction plate 18 with a contact face 30 that has the variable surface roughness qualities desired. The compliant layer 34 and the top layer 36 may act cooperatively through differences in their physical properties to have such an effect by reversibly forming wrinkles 38. These wrinkles 38 are formed, and correspondingly eliminated, in response to differential compressive thermal in-plane stresses that may be induced in the top layer 36 as a result of differential thermal strains generated between the complaint layer 34 and the top layer 36 during reversible temperature changes experienced by the reaction plate 18. The wrinkles 38 may be formed coextensively along the contact face 30 of the reaction plate 18 or, instead, at certain select portions thereof. Moreover, the wrinkles 38 on the contact face 30 may be randomly oriented or oriented in specific directions. For example, in one embodiment, all of the wrinkles 38 may be oriented in the same direction to provide the contact face 30 of the reaction plate 18 with a substantially variable isotropic coefficient of friction. In another embodiment, however, the contact face 30 may include localized clusters of wrinkles 38 that are each oriented in some particular direction to provide the contact face 30 with a substantially variable anisotropic coefficient of friction. Such localized orientation of the wrinkling pattern can be obtained by deliberately designing out-of-plane step-like structures in the complaint layer 34, thereby providing specific directions for in-plane stress relief and orientation of the wrinkles in the corresponding orthogonal direction.

To reversibly form these wrinkles 38 in response to temperature changes in the reaction plate 18, suitable material compositions and thicknesses of the compliant layer 34 and the top layer 36 may be chosen. The compositional and dimensional relationship between the compliant layer 34 and the top layer 36 is relevant because the critical stress required for wrinkling is generally a function of the layers' 34, 36 thickness, moduli of elasticity, and Poisson's ratio. For instance, in one embodiment, the materials that comprise the compliant layer 34 and the top layer 36 may be chosen so as to satisfy two conditions: first, the compliant layer 34 has a lower modulus of elasticity (stiffness) than the top layer 36; and second, the compliant layer 34 and the top layer 36 have coefficients of thermal expansion that differ to such an extent that the stiffer top layer 36 can experience a high enough in-plane compressive stress in response to temperature changes so that buckling instability and out-of-plane deformation of the top layer 36 occurs. The thicknesses of the compliant layer 34 and the top layer 36 may also be chosen to ensure that such out of plane deformation by the top layer 36 can be supported by the compliant layer 34 without delaminating the compliant layer 34 from the base substrate 32.

The top layer 36 may, for example, in various embodiments, have a modulus of elasticity that is about 10² to 10⁵ greater than that of the compliant layer 34. The top layer 36 may further have a coefficient of thermal expansion that constitutes about a 1.1 to about a 100 fold difference, either greater or lesser, than the axial stiffness (modulus×thickness) weighted average coefficient of thermal expansion of the composite reaction plate 18 including the base substrate 32, the complaint layer 34, and the top layer 36. The axial stiffness of each layer can be determined by multiplying the modulus of elasticity of each individual layer by its thickness. The axial stiffness weighted average coefficient of thermal expansion for multiple layers can be determined by multiplying the axial stiffness of each layer by the coefficient of thermal expansion of the material of each layer to obtain a product for each layer, finding a sum of the products, and dividing the sum by a sum of the axial stiffnesses of the layers.

In terms of thickness, the ratio of the thicknesses of the compliant layer 34 to the top layer 36 may, for example, range from about 1 to about 10⁶. The thickness of the compliant layer 34 may range anywhere from about 10 nm to about 1 cm, and more specifically from about 10 nm to about 800 nm, from about 800 nm to about 2 μm, from about 2 μm to about 20 μm, from about 20 μm to about 1 cm, and all other ranges contained therein but not explicitly recited. The thickness of the top layer 36 may range anywhere from about 10 nm to about 10 μm, and more specifically from about 10 nm to about 30 nm, from about 30 nm to about 50 nm, from about 50 nm to about 100 nm, from about 100 nm to about 500 nm, from about 500 nm to about 2 μm, from about 2 μm to about 10 μm, and all other ranges contained therein but not explicitly recited.

A variety of materials that can facilitate the reversible formation of the wrinkles 38 may be utilized to fabricate the compliant layer 34 and the top layer 36. The compliant layer 34 may be composed of a soft polymer or elastimeric material such, but not limited to, at least one of polydimethylsiloxane (PDMS), polystyrene (PS), polyethyl acrylate (PEA), natural rubber, polyisoprene, polybutadiene, a chloprene elastomer, a silicone elastomer, a flurosilicone elastomer, an ethylene propylene elastomer, a polyurethane elastomer, a polyacrylic elastomer, an epichlorohydrin elastomer, or a polysulfide elastomer. The compliant layer 34 may be applied to the base substrate 32 by any known manner such as deposition from a carrier solution followed by drying. The top layer 36, on the other hand, may be composed of a metal such as gold, nickel, aluminum, titanium, platinum, and chromium, a glassy polymer material such as polyvinyl alcohol, or a ceramic material such as silicon, silicon carbide, or silicon oxide. The top layer 36 may be applied to the compliant layer 34 by any known manner such as electron beam evaporation, thermal evaporation, ion sputtering, and deposition from a carrier solution followed by drying. An interlayer may also be applied between the compliant layer 34 and the top layer 36 to enhance the adherence between the two layers 34, 36, if desired. Such an interlayer may have a thickness of up to about 5 nm, and may be comprised of any known and useful bonding material such as titanium and chromium. Skilled artisans are capable of selecting, or otherwise determining through known procedures, which materials to select and how to combine those chosen materials to realize a contact face 30 that can reversibly form the wrinkles 38 to a desired size over a desired temperature range.

The wrinkles 38 may be formed across a broad spectrum of sizes. The wrinkles 38 may, in various embodiment, have a size defined by an average peak-to-peak wavelength that generally ranges from about 50 nm to about 2 mm, and more specifically from about 50 nm to 1 μ, 1 μm to 50 μm, from about 50 μm to 150 μm, from about 150 μm to about 180 μm, from about 180 μm to 200 μm, from about 200 μm to about 400 μm, and from about 450 μm to about 2 mm, and an average peak-to-trough amplitude that generally ranges from about 10 nm to about 10 μm. This flexibility in the size of the wrinkles 38 is possible because the magnitude of the in-plane compressive stress felt by the top layer 36—which, as previously explained, is at least partially responsible for formation of the wrinkles 38—is proportional to the temperature change imposed on the compliant layer 34, the top layer 36, and base substrate 32.

The equilibrium wavelength (peak-to-peak) and amplitude (peak-to-trough) of the wrinkles 38 are generally functions of the in-plane compressive stress felt by the top layer 36, the ratio of the moduli of elasticity, and the ratio of the thicknesses between the compliant layer 34 and the top layer 36. In general, the greater the in-plane compressive stress felt by the top layer 36 or the lower the ratio of the moduli of elasticity between the compliant layer 34 and the top layer 36, the greater the peak-to-trough amplitude of the wrinkles 38. The surface roughness of the contact face 30, which is generally an arithmetic or geometric averaged surface profile of wrinkle amplitude, can thus be modified by either increasing or decreasing the in-plane compressive stress felt by the top layer 36 through changes in temperature. The materials that comprise the compliant layer 34 and the top layer 36 may even be selected to achieve a particular ratio of the moduli of elasticity between the compliant layer 34 and the top layer 36. This design choice may provide for the more predictable and application-appropriate formation and elimination of wrinkles 38 on the contact face 30 over a known or desired range of operating temperatures. The ability to alter the magnitude of the in-plane compressive stress that can be put on the top layer 36 by varying the temperature of the reaction plate 18 or its immediate surrounding environment can thus be helpful in controlling the size of the wrinkles 38 and, in turn, the surface roughness and the operative coefficient of friction of the contact face 30.

The reversible formation of wrinkles 38 on the contact face 30 of the reaction plate 18 in response to temperature changes is shown schematically in FIGS. 3A-3B. The controllable formation and elimination of wrinkles 38 on the contact face 30 can, as already mentioned, influence the operative coefficient of friction of the contact face 30. FIG. 3A shows a partial cross-sectional view of the reaction plate 18 in which the contact face 30 is substantially flat. The contact face 30 is substantially flat because the compliant layer 34 and the top layer 36 are not exposed to conditions that can generate the necessary in-plane compressive stress in the top layer 36 that is needed to initiate wrinkling. Under these conditions, the contact face 30 of the reaction plate 18 has a relatively low coefficient of friction.

FIG. 3B, on the other hand, shows the same partial cross-sectional view of the reaction plate 18 depicted in FIG. 3A but now the contact face 30 comprises wrinkles 38. Here, the compliant layer 34, the top layer 36, and the base substrate 32 have experienced an appropriate increase or decrease in temperature—depending on the relationship of top layer's 36 coefficient of thermal expansion to that of the compliant layer 34 and base substrate—such that the top layer 36 has experienced an in-plane compressive stress that has been relieved through out-of-plane deformation of the top layer 36 to produce the wrinkles 38. The contact 30 face here, as a result, has a coefficient of friction that has increased from the coefficient of friction attributable to the substantially flat contact surface shown in FIG. 3A. These wrinkles 38 shown in FIG. 3B, however, may be reversibly eliminated to produce the substantially flat contact face 30 of FIG. 3A by proportionately counteracting the increase or decrease in temperature that originally formed the wrinkles 38. The controlled thermal cycling of the compliant layer 34 and the top layer 36 can thus result in the contact face 30 of the reaction plate 18 having a controllable surface roughness.

The temperature of the reaction plate 18, and more specifically the contact face 30, may be controlled in a multitude of fashions to help manage the surface roughness of the contact face 30 through the reversible formation or elimination of the wrinkles 38. In one embodiment, the materials that comprise the compliant layer 34 and the top layer 36 may be chosen, along with their respective thicknesses, so that the formation and elimination of the wrinkles 38 within a desired size range generally occurs in a predetermined and predictable fashion over a known and expected temperature operating range of the multi-disc clutch 10. In another embodiment, the temperature of the reaction plate 18 may be more directly controlled by, for example, controlling the flow of a cooling fluid to the multi-disc clutch 10 and the reaction plate 18. An example of such a system with related circuitry is described in U.S. Pat. No. 7,311,187. In still a further embodiment, the temperature of the reaction plate 18 and more particularly the temperature of the contact face 30 may be controlled by selective inductive heating.

The embodiments illustrated in FIGS. 1-3B show only the reaction plate 18 as a variable surface composite plate structure. This is done so only for ease of illustration. It should be understood that the composite plate structure can be used to form either the friction plate 16 or reaction plate 18 or both plates 16, 18. When the composite plate structure as described above is employed to form the friction plate 16, the disposition of a high-friction surface layer 28 on the friction plate's 16 contact face may not be necessary. It should also be understood that other load transfer devices may be equipped with a variable and controllable surface roughness as taught by this disclosure, and that the scope of this disclosure is not limited solely to the multi-disc clutch application shown and described herein as an exemplary embodiment.

The above description of embodiments of the invention is merely exemplary in nature and, thus, variations thereof are not to be regarded as a departure from the spirit and scope of the invention.

What is claimed is:

1. A product comprising:
a load-transfer device comprising a composite component that has a contacting surface constructed and arranged to selectively engage another surface to transfer power to or from the composite component, the composite component comprising a base substrate, a compliant layer over the base substrate, and a top layer over the compliant layer, and wherein the compliant layer and the top layer act cooperatively to reversibly form wrinkles in response to changes in temperature of the composite component.

2. The product as defined in claim 1, wherein the top layer comprises a modulus of elasticity that is about 10² to 10⁵ greater than that of the compliant layer and a coefficient of thermal expansion that is about a 1.1 to about a 100 fold difference from that of the axial stiffness weighted average coefficient of thermal expansion of the base substrate, the complaint layer, and the top layer.

3. The product as defined in claim 2, wherein each of the top layer and the compliant layer further comprises a thickness so that the ratio of the thicknesses of the compliant layer to the top layer is between about 1 and about 10⁶.

4. The product as defined in claim 3, wherein the thickness of the compliant layer is between about 10 nm and about 1 cm and the thickness of the top layer is between about 10 nm to about 10 μm.

5. The product as defined in claim 1, wherein the wrinkles, when formed, have an average peak-to-peak wavelength that ranges from about 50 nm to about 2 mm, and an average peak-to-trough amplitude that ranges from about 10 nm to about 10 μm.

6. The product as defined in claim 1, wherein the top layer is comprised of at least one of gold, nickel, aluminum, titanium, platinum, chromium, glassy polyvinyl alcohol, silicon, silicon carbide, or silicon oxide.

7. The product as defined in claim 1, wherein the compliant layer is comprised of at least one of polydimethylsiloxane, polystyrene, and polyethyl acrylate, natural rubber, polyisoprene, polybutadiene, a chloprene elastomer, a silicone elastomer, a flurosilicone elastomer, an ethylene propylene elastomer, a polyurethane elastomer, a polyacrylic elastomer, an epichlorohydrin elastomer, or polysulfide elastomer.

8. The product as defined in claim 1, wherein the wrinkles can be reversibly formed coextensively along the contacting surface of the composite component.

9. The product as defined in claim 1, wherein the wrinkles can provide the contacting surface of the composite component with either an isotropic or anisotropic coefficient of friction.

10. The product as defined in claim 1, wherein the component is a clutch plate.

11. A product comprising:
a composite clutch plate comprising a contact face configured to selectively engage an opposed high-friction surface layer of another clutch plate to transfer power between the clutch plates, the composite clutch plate comprising a base substrate, a compliant layer over the base substrate, and a top layer over the compliant layer, and wherein the compliant layer and the top layer act cooperatively to reversibly form wrinkles in response to changes in temperature of the composite clutch plate.

12. The product as defined in claim 11, wherein the top layer comprises a modulus of elasticity that is about 10² to 10⁵ greater than that of the compliant layer and a coefficient of thermal expansion that is about a 1.1 to about a 100 fold difference from that of the axial stiffness weighted average coefficient of thermal expansion of the base substrate, the complaint layer, and the top layer, and wherein each of the top layer and the compliant layer further comprises a thickness so that the ratio of the thicknesses of the compliant layer to the top layer is between about 1.1 and about 10⁶.

13. The product as defined in claim 12, wherein the thickness of the compliant layer is between about 10 nm and about 1 cm and the thickness of the top layer is between about 10 nm to about 10 μm.

14. The product as defined in claim 11, wherein the wrinkles, when formed, have an average peak-to-peak wavelength that ranges from about 50 nm to about 2 mm, and an average peak-to-trough amplitude that ranges from about 10 nm to about 10 μm.

15. The product as defined in claim 11, wherein the top layer is comprised of at least one of gold, nickel, aluminum, titanium, platinum, chromium, glassy polyvinyl alcohol, silicon, silicon carbide, or silicon oxide, and wherein the compliant layer is comprised of at least one of polydimethylsiloxane, polystyrene, polyethyl acrylate, natural rubber, polyisoprene, polybutadiene, a chloprene elastomer, a silicone elastomer, a flurosilicone elastomer, an ethylene propylene elastomer, a polyurethane elastomer, a polyacrylic elastomer, an epichlorohydrin elastomer, or a polysulfide elastomer.

16. The product as defined in claim 11, wherein the wrinkles can provide the contact face of the composite component with either an isotropic or anisotropic coefficient of friction.

17. A product comprising:
a vehicle that comprises a composite component having a contact surface, the composite component comprising a base substrate, a compliant layer over the base substrate, and a top layer over the compliant layer, and wherein the compliant layer and the top layer act cooperatively to reversibly form wrinkles in response to changes in temperature of the composite component such that the wrinkles, when formed, have an average peak-to-peak wavelength that ranges from about 50 nm to about 2 mm, and an average peak-to-trough amplitude that ranges from about 10 nm to about 10 μm.

18. A method comprising:
providing a load transfer device that comprises a composite component having a contact surface, the composite component comprising a base substrate, a compliant layer over the base substrate, and a top layer over the compliant layer, and wherein the top layer comprises a modulus of elasticity that is about 10² to 10⁵ greater than that of the compliant layer and a coefficient of thermal expansion that is about a 1.1 to about a 100 fold difference from that of the axial stiffness weighted average coefficient of thermal expansion of the base substrate, the complaint layer, and the top layer, and further wherein each of the top layer and the compliant layer comprises a thickness so that the ratio of the thicknesses of the compliant layer to the top layer is between about 1 and about 10⁶;
selectively engaging the contact surface of the composite component with an opposed surface of another component to transfer power to or from the composite component; and
reversibly forming wrinkles on the contact surface of the composite component by affecting the temperature of the composite component such that in-plane compressive stress experience by the top layer is relieved through out-of-plane deformation of the top layer.

19. The method as defined in claim 17, wherein reversibly forming the wrinkles comprises reversibly forming wrinkles that have an average peak-to-peak wavelength that ranges from about 50 nm to about 2 mm, and an average peak-to-trough amplitude that ranges from about 10 nm to about 10 μm.

20. The method as defined in claim 17, wherein providing a load transfer device comprises providing a load transfer device wherein the top layer is comprised of at least one of gold, nickel, aluminum, titanium, platinum, chromium, glassy polyvinyl alcohol, silicon, silicon carbide, or silicon oxide, and wherein the compliant layer is comprised of at least one of polydimethylsiloxane, polystyrene, polyethyl acrylate natural rubber, polyisoprene, polybutadiene, a chloprene elastomer, a silicone elastomer, a flurosilicone an elastomer, an ethylene propylene elastomer, a polyurethane elastomer, a polyacrylic elastomer, an epichlorohydrin elastomer, and a polysulfide elastomer.
